(19) United States
(12) Patent Application Publication
(10) Pub. No.: US 2011/0225834 A1
(43) Pub. Date: Sep. 22, 2011

(54) SHAVING RAZOR STORAGE, CLEANING AND PRESERVATION DEVICE

(76) Inventor: Dante Cirilli, Naples, FL (US)

(21) Appl. No.: 12/724,702

(22) Filed: Mar. 16, 2010

(51) Int. Cl. A45D 27/24; B65D 81/24; A45C 11/00; B08B 1/00; A47L 25/00

(52) U.S. Cl. 30/541; 206/208; 206/352; 15/104.92; 15/106

(57) ABSTRACT

A container (1) having a removable lid (3) for holding a shaving razor (6) and a liquid solution (7), preferably of water and alcohol. The lid has an opening (4) for accepting the head (5) of a shaving razor (6). A gasket (10) located around the opening seals the container and prevents the liquid solution from evaporating. Measurement lines (8) located on the perimeter wall (2) of the container indicate how much liquid solution to place in the container. A shaving razor may be placed into the container through the opening and the gasket so that the head of the razor with the blade cartridge is submerged in the alcohol and water solution and the handle of the razor extends out of the lid through the opening and the gasket, which forms a seal around the handle (9), thereby helping to prevent the liquid solution from evaporating. A brush (13) located on the inner surface (14) of the lid cleans any debris from the head of the shaving razor as the shaving razor is inserted or removed from the container

### BACKGROUND OF THE INVENTION

This invention relates to shaving razors, more particularly, a container used for storing, cleaning, disinfecting and preserving a manual or non-electric shaving razor.

Men and women commonly use shaving razors to remove hair from various parts of the body. Over the years, razors, specifically new blade cartridges used to replace dull and worn out blade cartridges, have become increasingly expensive. Many people believe cutting hair and whiskers is the primary reason that blades become dull and need to be replaced. However, it is corrosion, not the cutting of hair and whiskers that is the primary reason for the dulling of the blades. Blades are especially vulnerable to corrosion because they are often put away after use without being dried. Blades are also stored in bathrooms where the air is humid. The combination of moisture and exposure to air causes corrosion and thus, dulling of the blade. In addition, razors are normally placed on bathroom counter tops, thereby cluttering and dirtying the counter top, as well as exposing the shaving razor to germs.

Therefore, a need exists for a device, the primary object of which is preventing shaving razors from corroding and becoming dull prematurely, with secondary objects of cleaning, sterilizing and convenient storing of the shaving razor.

The relevant prior art includes the following references:

| Pat. No. | | |
|---|---|---|
| (U.S. unless stated otherwise) | Inventor | Issue/Publication Date |
| 7,559,330 | Christenen, Sr. | Jul. 14, 2009 |
| 7,134,935 | Papetti | Nov. 14, 2006 |
| 6,634,492 | Cox | Oct. 21, 2003 |
| 6,039,937 | Neubauer | Mar. 21, 2000 |
| 5,934,459 | Winsell | Aug. 10, 1999 |
| 5,251,752 | Purohit | Oct. 12, 1993 |
| 5,007,533 | Purohit | Apr. 16, 1991 |
| 4,629,753 | Quinn | Dec. 16, 1986 |
| 3,759,954 | Cobb | Sep. 18, 1973 |
| 3,352,630 | Fischer et al. | Nov. 14, 1967 |
| 3,019,494 | Hori et al. | Feb. 06, 1962 |
| 2,443,495 | Teusta | Jun. 15, 1948 |
| 2,356,106 | Vineberg | Aug. 15, 1944 |
| 2,177,815 | Strock | Oct. 31, 1939 |
| 1,956,743 | Lifton | May 01, 1934 |

### SUMMARY OF THE INVENTION

The primary object of the present invention is to provide a shaving razor storage, cleaning and preservation device that prevents the blade(s) of the shaving razor from corroding and dulling.

Another object of the present invention is to provide a shaving razor storage, cleaning and preservation device that cleans the blade(s) of the shaving razor. An even further object of the present invention is to provide a shaving razor storage, cleaning and preservation device that sterilizes the shaving razor and blades.

Another object of the present invention is to provide a shaving razor storage, cleaning and preservation device that provides an aesthetically pleasing storage area for shaving razors.

The present invention fulfills the above and other objects by providing a container having a removable lid with an opening for accepting the head of a shaving razor. The lid may have a gasket around the opening. A scrubbing means, such as a brush, may be located on the inner surface of the lid around the opening to clean any debris from the head of the shaving razor as the shaving razor is inserted or removed from the container. The container holds a predetermined amount of liquid solution, preferably water and alcohol, to help preserve and disinfect the razor. Marks located on the side of the container indicate how much water and alcohol to place in the container.

To use, a user first pours alcohol into the container, thereby filling the container to a predetermined mark. Then the user pours water into the container, thereby filling the container to a second predetermined mark. Next, the user places the lid on top of the container. Finally, the user places a shaving razor into the container through the opening and the gasket so that the head of the razor with the blade cartridge is submerged in the alcohol and water solution and the handle of the razor extends out of the lid through the opening and the gasket, which forms a seal around the handle, thereby preventing the mixture of alcohol and water from evaporating. Submerging the blade cartridge in the solution prevents the blades from coming into contact with the air and thus, prevents corrosion. In addition, the alcohol in the solution disinfects the blade.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective-view of a shaving razor storage, cleaning and preservation device of a preferred embodiment the present invention;

FIG. 2 is a top view a the lid from the shaving razor storage, cleaning and preservation device of FIG. 1;

FIG. 3 is a cross sectional view of a lid along line 3-3 in FIG. 2 of the shaving razor storage, cleaning and preservation device; and

FIG. 4 is a bottom view of a lid from the shaving razor storage, cleaning and preservation device of FIG. 1.

### DESCRIPTION OF THE PREFERRED EMBODIMENTS

For purposes of describing the preferred embodiment, the terminology used in reference to the numbered accessories in the drawings is as follows:

| | |
|---|---|
| 1. | container |
| 2. | perimeter wall |
| 3. | lid |
| 4. | opening |
| 5. | head |
| 6. | shaving razor |
| 7. | liquid solution |
| 8. | measurement line |
| 9. | handle |
| 10. | gasket |
| 11. | slit |
| 12. | scrubbing means |
| 13. | brush |
| 14. | inner surface |

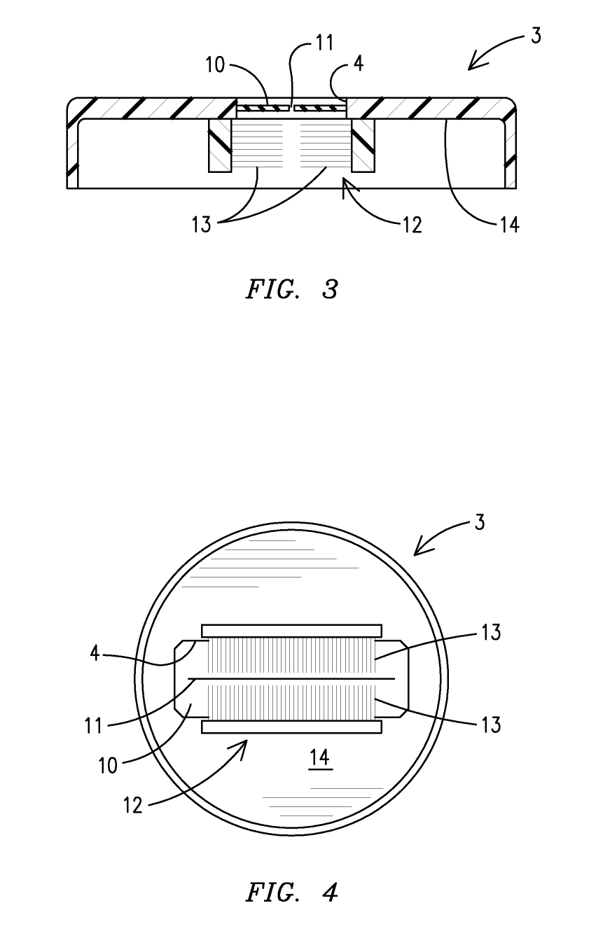

With reference to FIG. 1, a perspective view of a preferred embodiment of a shaving razor storage, cleaning and preservation device of the present invention is shown. The shaving razor storage, cleaning and preservation device comprises a container 1 having a perimeter wall 2 extending upward from a base 2. As shown here, the perimeter wall 2 is constructed out of a translucent material, such as glass or plastic. A lid 3 is removably attachable to the container 1. An opening 4, as shown further in FIGS. 3 and 4, for accepting the head 5 of a shaving razor 6 is located on the lid 3. A preserving and disinfecting liquid solution 7, preferably of water and alcohol, is stored in the container 1. Measurement lines 8 located on the perimeter wall 2 of the container 1 indicate how much water and alcohol to place in the container 1. A shaving razor 6 may be placed into the container 1 through the opening 4 in the lid 3 so that the head 5 of the shaving razor 6 is fully submerged in the liquid solution 7 and the handle 9 of the shaving razor 6 extends out of the lid 3 through the opening 4.

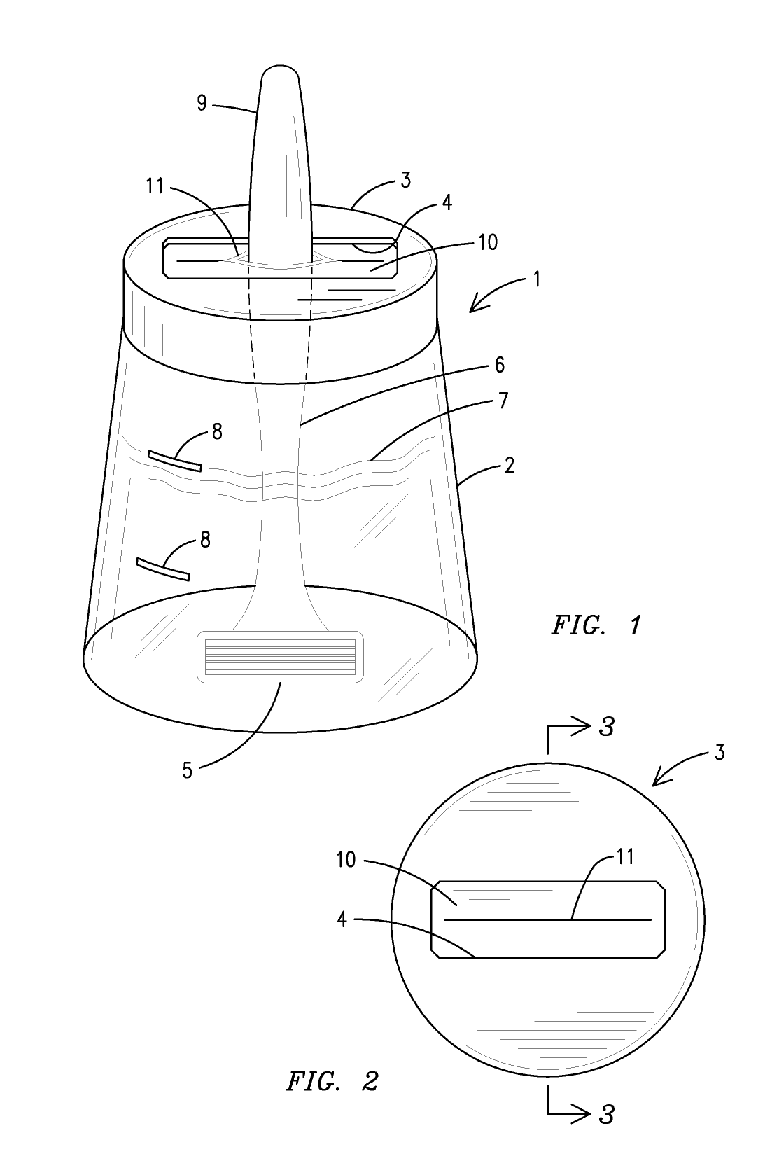

With reference to FIG. 2, a top view a the lid 3 from the shaving razor storage, cleaning and preservation device of FIG. 1 is shown. The lid 3 has an opening 4 for accepting the head of a shaving razor. A gasket 10 having a slit 11 is located around the opening seals the opening 4 to help prevent or delay any liquid solution 7 held within the container 1 from evaporating. The gasket is preferable made of a flexible material, such as rubber. The slit 11 allows a user to place a shaving razor 6 into the container 1 through the opening 4 and the gasket 10. In addition, the gasket 10 forms a seal around the handle 9 of the shaving razor 6, thereby helping to prevent any liquid solution 7 from evaporating out of the container 1.

Finally, with reference to FIGS. 3 and 4, a cross sectional view along line 3-3 of FIG. 2 and a bottom view, respectively, of a lid 3 from a preferred embodiment of the shaving razor storage, cleaning and preservation device of the present invention is shown. The lid 3 has an opening 4 for accepting the head of a shaving razor. A gasket 10 having a slit 11 is located around the opening seals the opening 4 and prevents any liquid solution 7 held within the container 1 from evaporating. The slit 11 allows a user to places a shaving razor 6 into the container 1 through the opening 4 and the gasket 10. In addition, the gasket 10 forms a seal around the handle 9 of the shaving razor 6, thereby preventing any liquid solution 7 from evaporating out of the container 1. A scrubbing means 12, such as a brush 13, is located on the inner surface 14 of the lid 3 around the opening 4. The scrubbing means 12 cleans any debris from the head 5 of the shaving razor 6 as the shaving razor 6 is inserted or removed from the container 1.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A shaving razor holding device comprising:
a container having a base with at least one perimeter wall extending upward from the base;
a lid that is removably attachable to the container; and
an opening located in the lid that allows a user to insert a head of a shaving razor into the container.

2. The shaving razor holding device of claim 1 further comprising:
a gasket located in the opening;
a slit located in the gasket that allows a user to insert a head of a shaving razor into the container.

3. The shaving razor holding device of claim 1 further comprising:
a scrubbing means located on an inner surface of the lid.

4. The shaving razor holding device of claim 3 wherein:
said scrubbing means is a brush.

5. The shaving razor holding device of claim 1 further comprising:
a liquid solution located inside the container.

6. The shaving razor holding device of claim 5 wherein:
said liquid solution is a mixture of alcohol and water.

7. The shaving razor holding device of claim 1 further comprising:
at least one measurement line located on the perimeter wall.

8. A shaving razor holding device comprising:
a container having a base with at least one perimeter wall extending upward from the base;
a lid that is removably attachable to the container;
an opening located in the lid;
a gasket located in the opening; and
a slit located in the gasket that allows a user to insert a head of a shaving razor into the container.

9. The shaving razor holding device of claim 8 further comprising:
a scrubbing means located on an inner surface of the lid.

10. The shaving razor holding device of claim 9 wherein:
said scrubbing means is a brush.

11. The shaving razor holding device of claim 8 further comprising:
a liquid solution located inside the container.

12. The shaving razor holding device of claim 11 wherein:
said liquid solution is a mixture of alcohol and water.

13. The shaving razor holding device of claim 8 further comprising:
at least one measurement line located on the perimeter wall.

14. A shaving razor holding device comprising:
a container having a base with at least one perimeter wall extending upward from the base;
a lid that is removably attachable to the container;
an opening located in the lid;
a gasket located in the opening;
a slit located in the gasket that allows a user to insert a head of a shaving razor into the container; and
a scrubbing means located on an inner surface of the lid.

15. The shaving razor holding device of claim 14 wherein:
said scrubbing means is a brush.

16. The shaving razor holding device of claim 14 further comprising:
a liquid solution located inside the container.

17. The shaving razor holding device of claim 16 wherein:
said liquid solution is a mixture of alcohol and water.

18. The shaving razor holding device of claim 14 further comprising:
at least one measurement line located on the perimeter wall.
